(19) United States
(12) Patent Application Publication
(10) Pub. No.: US 2004/0239135 A1
(43) Pub. Date: Dec. 2, 2004

(54) Camper slide-out having pivotable chairs

(76) Inventor: Robert Mehrer, Penticton (CA)

Correspondence Address: ANTONY C. EDWARDS, SUITE 800 - 1708 DOLPHIN AVENUE, KELOWNA, BC, V1Y 9S4, CA

(21) Appl. No.: 10/815,722

(22) Filed: Apr. 2, 2004

Related U.S. Application Data
(60) Provisional application No. 60/467,622, filed on May 5, 2003.

(51) Int. Cl. B60P 3/34

(52) U.S. Cl. 296/26.13

(57) ABSTRACT

A camper slide-out having pivotable chairs includes a slide-out for mounting into the side of a camper adapted so as to translate the slide-out laterally relative to the camper and above the side walls of a pickup truck when the slide-out is mounted into the camper and the camper is mounted into the bed of the pickup truck. At least one chair is pivotably mounted on in the slide-out for pivoting between a first alignment aligned fore-and-aft along the camper so that user sitting in said chair faces fore or aft, and a second alignment angularly pivoted by an angular displacement from the first alignment.

### CROSS REFERENCE TO RELATED APPLICATION

This application claims priority from U.S. Provisional Patent Application No. 60/467,622 filed May 5, 2003 entitled Camper Slide-out Having Pivotable Chairs.

### FIELD OF THE INVENTION

This invention relates to the field of recreational vehicles and in particular to the field of campers which may be mounted into the beds of pickup trucks and to such campers being equipped with slide-outs having mounted therein reclineable pivoting chairs.

### BACKGROUND OF THE INVENTION

So called slide-outs are known in the prior art associated with recreational vehicles (RV's), such as motor coaches, camper trailers and campers which mount into pickup truck beds. Slide-outs are compartments which typically telescopically extend laterally outwardly from the sides of RV's. Once so extended, slide-outs increase the inside lateral dimensions of the living space within the RV, which, because the RV must be transported on a public roadway, is limited by the maximum allowed lateral vehicle dimension, that is width, for example eight and one half feet in some jurisdictions.

In such slide-outs it is sometimes common to have a pair of opposed facing fixed bench seats, sometimes with a table mounted therebetween. The use of such fixed bench seats is a natural hold-over from the use of such seats in RV's before slide-outs became commonplace. Before the use of slide-outs in RV's, the living space in an RV was so limited that, in order for there to be a narrow unobstructed passageway running fore and aft along the RV, users of the RV generally had to sit in opposed facing bench seats so that the users were, when seated, either facing directly forward or directly aft. Alternatively, if the bench-seat was a single bench along the side wall of the RV, a user would sit skewed on the bench to keep the user's feet as clear of the passageway as possible when the passageway was in use. Upon the introduction of slide-outs, the bench seat arrangements were duplicated within the slide-out, even though the slide-out could be extended laterally of the RV from a closed position occluding or covering the passageway, to an opened or extended position leaving the central fore-to-aft passageway uncovered.

### SUMMARY OF THE INVENTION

In the prior art the full flexibility of use of an RV slide-out was not being exploited by the use of fixed bench seats in such slide-outs. In the open position, the RV slide-out creates sufficient room not only to install side-by-side lounger-like chairs, so-called captain's chairs, in fore-to-aft alignment, but to install at least one lounger-like chair which may be rotated about a vertical axis of rotation. Once rotated so that a user was pivoted for example forty-five degrees from a fore-to-aft longitudinal alignment, an RV slide-out provides sufficient lateral room so that the captain's chair may also be reclined, in the manner of a reclining lounge chair, previously not possible in RV's not having slide-outs.

Consequently the present invention includes at least one, and may include at least a pair of side-by-side separate lounge chairs mounted into an RV slide-out compartment. The RV slide-out compartment may be generally rectangular, having a floor, opposite fore and aft walls, a ceiling, and an outer side wall, all of which mounted contiguously to form an enclosed compartment opening into the inside of the RV and slideably mounted into a side wall or other wall of the RV. One of the lounge chairs, typically the chair closest to the fore-to-aft passageway of the RV when the slide-out is extended in its open position, may be swivelled about a vertical axis and reclined from an upright position into a laid-back position, with or without automatically extending foot rests, when swivelled out of a longitudinally oriented alignment that is fore-to-aft.

In summary, the present invention may be characterized as a camper slide-out having pivotable chairs. The slide-out may be built in to a camper for sale as a complete unit, or may be sold separately, for example, for retro fit or later assembly into a new camper. In the latter case, the present invention is characterized as a slide-out for mounting into the side of a camper adapted so as to translate the slide-out laterally relative to the camper and above the side walls of a pickup truck when the slide-out is mounted into the camper and the camper is mounted into the bed of the pickup truck. In the former case, the present invention is characterized as including both a camper mountable into the bed of a pickup truck, and a slide-out for mounting into the side of a camper adapted so as to translate the slide-out laterally relative to the camper and above the side walls of a pickup truck when the slide-out is mounted into the camper and the camper is mounted into the bed of the pickup truck.

In both cases at least one chair is pivotably mounted on pivot means in the slide-out for pivoting between a first alignment aligned fore-and-aft along the camper so that user sitting in the chair faces fore or aft, and a second alignment angularly pivoted by an angular displacement from the first alignment. The chair includes means for selectively translating in a translation direction the chair from a rearward position wherein a back surface of the chair is closely adjacent a wall of the slide-out, and a foreward position wherein the back surface of the chair has a clearance between it and the wall of the slide-out so that the chair may be pivoted between the first and second alignments without the back surface of the chair contacting the wall of the slide-out. In preferred embodiments, the wall of the slide-out adjacent the back of the chair is a fore or aft wall of the slide-out.

The chair may be a reclinable chair in which case the clearance and angular displacement are sufficient so that the chair may be reclined without the wall of the slide-out interfering with the reclining of the chair. For example, the angular displacement may be generally 45 degrees.

The means for selectively translating the chair may include a first slide member rigidly mounted under a seat of the chair and a second slide member rigidly mounted, such as an elongate rail, to a pedestal, wherein the first and second slide members are mounted to one another so as to co-operate in sliding relative engagement. The pivot means may include means for rotatably mounting the second slide member onto the pedestal for rotation of the first and second slide members about a vertical axis of rotation. The first and second slide members may be elongate and may be aligned longitudinally parallel to the translation direction of the chair. The first and second slide members may include a pair of first slide members and a pair of second slide members.

A selectively releasable latch may be provided for releasably locking the first slide member relative to the second slide member when the first slide member has been translated relative to the second slide member in the translation direction.

### BRIEF DESCRIPTION OF THE DRAWINGS

FIG. 1 is, in perspective view, a pickup truck mounted camper having a slide-out according to the present invention in its open position.

FIG. 2 is, in perspective view, the interior of the slide-out of FIG. 1 when viewed from inside the camper prior to deployment of the rotatable and reclineable captain's chairs.

FIG. 3 is the view of FIG. 2 with a pair of captain's chairs in the deployed and rotated position prior to being reclined.

FIG. 4 is, in perspective view, a chair according to one embodiment of the present invention.

FIG. 5 is, in plan view, the chair of FIG. 4.

### DETAILED DESCRIPTION OF EMBODIMENTS OF THE INVENTION

In the prior art, it is well known to mount a so-called camper 10 into the bed of a conventional pickup truck 12. In the past however it has been unknown to incorporate a slide-out compartment 14 into the side 10a of a camper 10. Heretofore, slide-outs have been employed in larger motor coaches and so-called fifth-wheel trailers to increase the size of interior accommodation. In the prior art, applicant is unaware of the use of slide-outs in campers mounted into the beds of pickup trucks wherein the camper has to be adapted so that the slide-out clears over the sidewall of the pickup truck bed, and yet still provides for a floor space of increased volume which is useable within the camper enclosure.

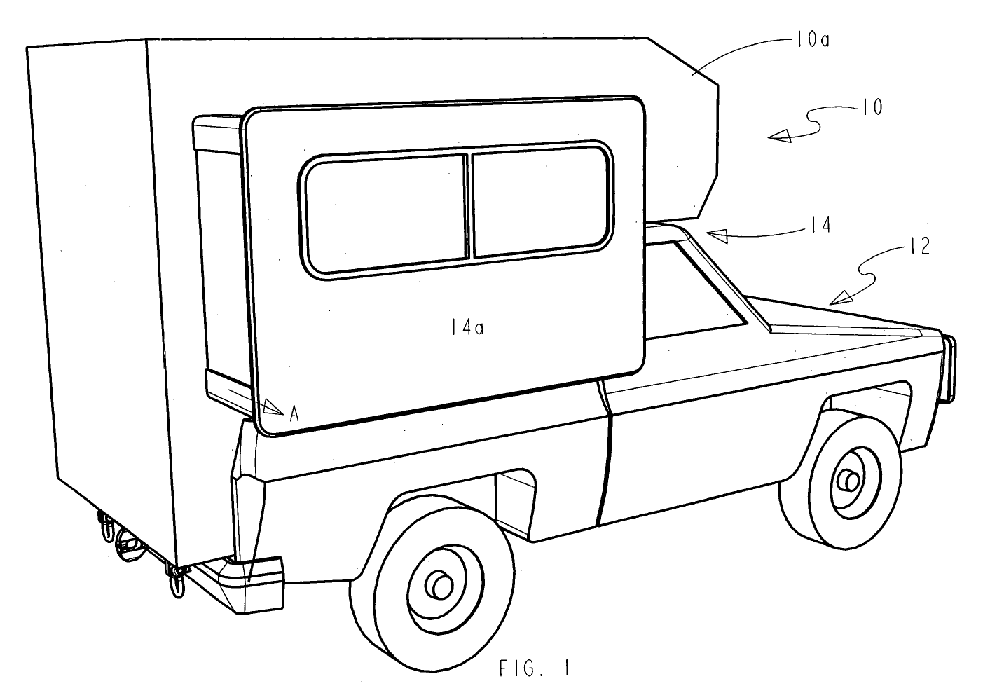

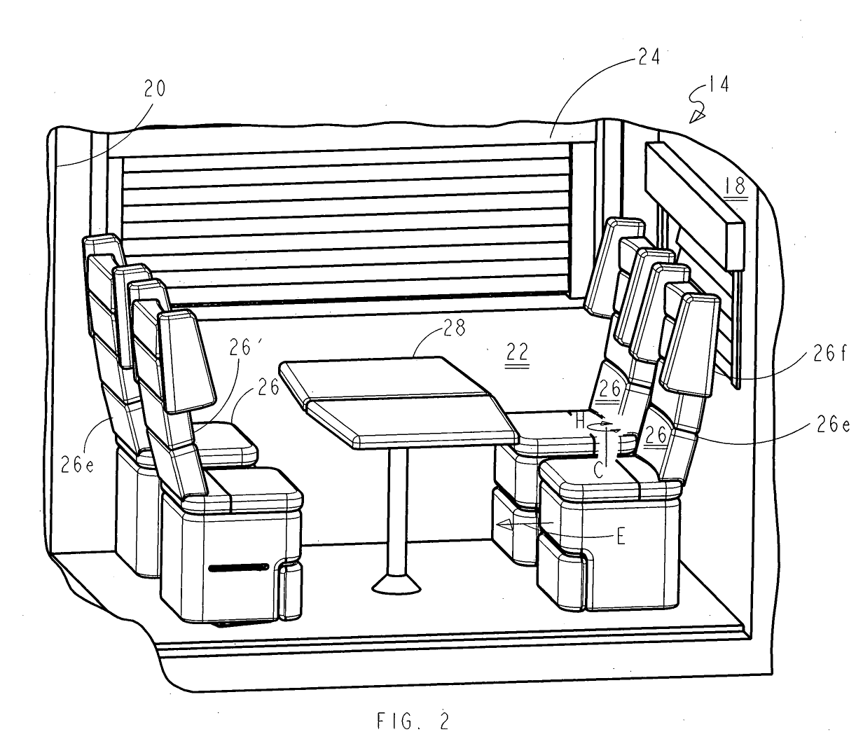

Thus, as seen in FIG. 1, when a slide-out according to one aspect of the present invention translates laterally of the longitudinal axis of the camper and truck in direction A, as seen in FIG. 2 there is a corresponding lateral sliding in direction B of the interior slide-out compartment. The slide-out compartment, in the embodiment illustrated in FIG. 2, which is not intended to be limiting, has a base platform 16, fore and aft walls 18 and respectively, and contiguously extending therebetween a sidewall 22 into which is mounted a window and window frame 24. Between them, the base platform, fore and aft walls, and sidewall define an enclosure of sufficient size in to which may be mounted, again by way of example, opposed facing captains chairs 26 and a fold-down table 28 therebetween. A ceiling surface (not shown) extends rigidly over the enclosure as defined by the fore and aft walls and the sidewall.

Slide-out 14 may be translated laterally into its closed position in a direction opposite to direction B. In its closed position the outer surface 14a of slide-out 14 as seen in FIG. 1, which corresponds to sidewall 22 in FIG. 2, is recessed generally flush with camper sidewall 10a during transportation of the camper and for example during storage of the camper when not in use. When pickup truck 12 has been parked and it is desired to use camper 10, slide-out 14 is translated outwardly in direction A so as to cause the corresponding sliding translation in direction B of base platform 16 to thereby clear the four-to-aft walkway of the obstruction of the slide-out 14 when in its closed position.

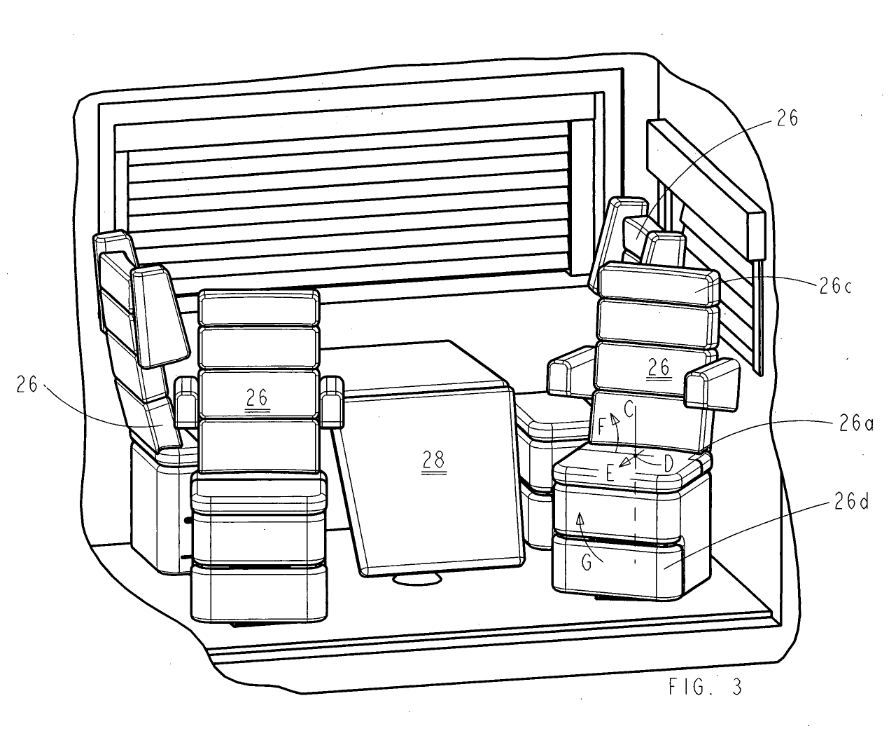

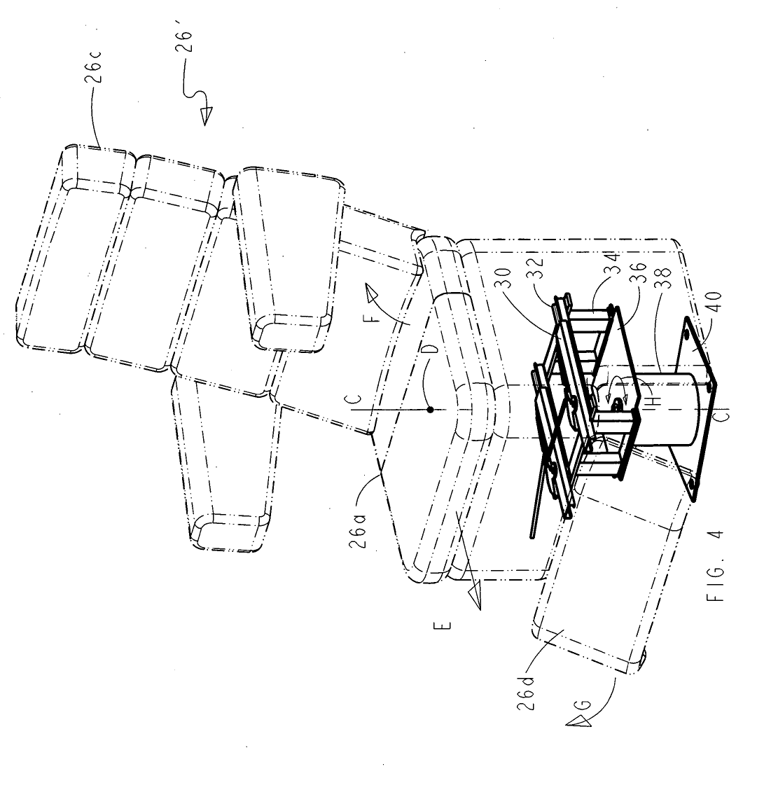

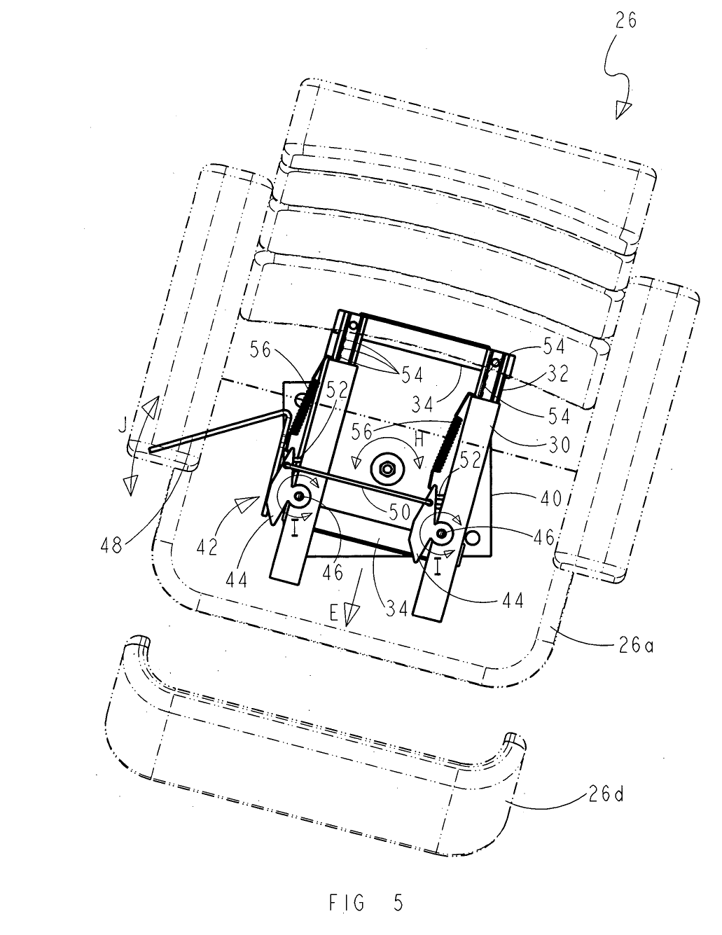

With slide-out 14 in its fully open position, thereby clearing the space for example equivalent to walkway 30, the interior of the camper has an enlarged useable volume, which is enlarged by the corresponding displacement of slide-out 14 in its displacement between its closed and its opened position. This enlarged enclosure within the camper provides an enlarged useful area which may be taken advantage of by the employment of captain's chairs 26 and 26′ and in particular those chairs 26′ closest to walkway 30. Captain's chairs 26′, being those captain's chairs closest to walkway 30, are of a design which may be rotated about a generally vertical axis C which for example passes through a midpoint D of the seat portion 26a, and which may for example be translated forwardly in direction E and then reclined in direction F as seen in FIG. 3. Further, captain's chairs 26′ may be of a design where, as the seat back 26c reclines in direction F, a foot rest 26d rotates upwardly in direction G into an elevated foot supporting position as seen in dotted outline partially elevated in FIGS. 4 and 5. In this manner, captain's chairs 26′ take advantage of the increased area within the camper afforded by the use of slide-out 14 which would otherwise be vertically impossible because of the small confines of a conventional camper which has to fit between the walls of the bed of a pickup and not exceed, while travelling, the maximum permitted vehicle width, for example in some jurisdictions eight and one half feet. The forward translation, pivoting and reclining, of captain's chairs 26′, for example when table 28 is folded down, afford the user of a camper the impression of a spacious, or at least more spacious, living room within the confines of the camper.

Thus as seen in FIGS. 4 and 5, it is advantageous if chairs 26′ are provided with a mechanism allowing the forward translation and pivoting of the chair relative to the confining walls 18 and 20 of slide-out 14. Thus the underside of the seat of the chair may be rigidly mounted to upper channel slides 30, themselves slidably mounted onto lower channel rails 32. Rails 32 are rigidly mounted onto platform frame 34, the platform frame 34 rigidly mounted onto platform 36. Platform 36 is pivotably mounted onto a pedestal 38 having a base 40 for rotation of platform 36 in direction H about axis C. Base 40 is bolted to the floor of the slide-out.

A spring-loaded latch mechanism 42 may be mounted onto upper channel slides so that upper channel slides 30 may be releasably locked onto lower channel rails 32 in positions selectable along the length of the rails. In particular, pivot arms 44 are pivotably mounted by pins 46 onto the upper surfaces of upper channel slides 30 for rotation in direction I. A handle 48 is rigidly mounted to a first of the pair of pivot arms 44. A cross-linking arm 50 connects the pair of pivot arms 44 so that rotation of the first pivot arm in direction I by a moment applied to the end of handle 48 in direction J results in rotation in direction I of both pivot arms 44. Thus pushing handle 48 toward the front of the seat 26′ rotates pivot arms 44 about pins 46 so as to disengage latch pins 52, which are rigidly mounted to pivot arms 44, from their journalled engagement in corresponding apertures 54. Apertures 54 are formed in longitudinally spaced array along the length of lower channel rails 32. With latch pins 52 disengaged from mating engagement into apertures 54, seat 26′ may be slid in direction E by sliding slides 30 over rails 32 until the desired seat position is achieved. Once the desired seat position is achieved, handle 48 is released and latch pins 52 re-mate into the corresponding apertures 54 on rails 32 under the resilient urging of coil springs 56 which resiliently bias pivot arms 44 so as to engage latch pins 32 against slides 30.

Thus in the illustrated example of FIG. 2, once slide-out 14 has been extended to its open position, and the user prefers to convert a chair 26′ into a reclining lounger, the user would sit in the seat, grasp the end of handle 48 and push it forwardly relative to the seat, and then slide the seat in direction E so as to create some clearance between the back 26e of the seat and the wall; in the illustrations either wall 18 or wall 20. With the clearance then between the back of the seat and the wall, the chair may be pivoted in direction H without the back of the chair or armrests 26f bumping into the walls which would interfere with rotation of the seat to a position allowing for reclining.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A camper slide-out having pivotable chairs comprising:
a slide-out for mounting into the side of a camper adapted so as to translate said slide-out laterally relative to the camper and above the side walls of a pickup truck when the slide-out is mounted into the camper and the camper is mounted into the bed of the pickup truck,
at least one chair pivotably mounted on pivot means in said slide-out for pivoting between a first alignment aligned fore-and-aft along the camper so that user sitting in said chair faces fore or aft, and a second alignment angularly pivoted by an angular displacement from said first alignment,
at least one chair including means for selectively translating in a translation direction said chair from a rearward position wherein a back surface of said chair is closely adjacent a wall of said slide-out, and a foreward position wherein said back surface of said chair has a clearance between it and said wall of said slide-out so that said chair may be pivoted between said first and second alignments without said back surface of said chair contacting said wall of said slide-out.

2. The device of claim 1 wherein said wall of said slide-out is a fore or aft wall of said slide-out.

3. The device of claim 1 wherein said at least one chair is a reclinable chair and wherein said clearance and said angular displacement aresufficient so that said chair may be reclined without said wall of said slide-out interfering with the reclining of said chair.

4. The device of claim 3 wherein said angular displacement is generally 45 degrees.

5. The device of claim 1 wherein said means for selectively translating said at least one chair includes a first slide member rigidly mounted under a seat of said at least one chair and a second slide member rigidly mounted to a pedestal, wherein said first and second slide members are mounted to one another so as to co-operate in sliding relative engagement.

6. The device of claim 5 wherein said pivot means includes means for rotatably mounting said second slide member onto said pedestal for rotation of said first and second slide members about a vertical axis of rotation.

7. The device of claim 6 wherein said first and second slide members are elongate and are aligned longitudinally parallel to said translation direction.

8. The device of claim 7 wherein said first and second slide members are respectively, at least one slide member slidably coupled onto at least one rail.

9. The device of claim 8 further comprising a selectively releasable latch for releasably locking said first slide member relative to said second slide member when said first slide member has been translated relative to said second slide member in said translation direction.

10. A camper and slide-out having pivotable chairs comprising: a camper mountable into the bed of a pickup truck, and a slide-out for mounting into the side of a camper adapted so as to translate said slide-out laterally relative to the camper and above the side walls of a pickup truck when the slide-out is mounted into the camper and the camper is mounted into the bed of the pickup truck,
a chair pivotably mounted on pivot means in said slide-out for pivoting between a first alignment aligned fore-and-aft along the camper so that user sitting in said chair faces fore or aft, and a second alignment angularly pivoted by an angular displacement from said first alignment,
said chair including means for selectively translating in a translation direction said chair from a rearward position wherein a back surface of said chair is closely adjacent a wall of said slide-out, and a foreward position wherein said back Surface of said chair has a clearance between it and said wall of said slide-our so that said chair may be pivoted between said first and second alignments without said back surface of said chair contacting said wall of said slide-out.

11. The device of claim 10 wherein said wall of said slide-out is a fore or aft wall of said slide-out.

12. The device of claim 10 wherein said chair is a reclinable chair and wherein displacement is sufficient so that said chair may be reclined without said wall of said slide-out interfering with the reclining of said chair.

13. The device of claim 12 wherein said angular displacement is generally 45 degrees.

14. The device of claim 10 wherein said means for selectively translating said chair includes a first slide member rigidly mounted under a seat of said chair and a second slide member rigidly mounted to a pedestal, wherein said first and second slide members are mounted to one another so as to co-operate in sliding relative engagement.

15. The device of claim 14 wherein said pivot means includes means for rotatably mounting said second slide member onto said pedestal for rotation of said first and second slide members about a vertical axis of rotation.

16. The device of claim 15 wherein said first and second slide members are elongate and are aligned longitudinally parallel to said translation direction.

17. The device of claim 16 wherein said first and second slide members are respectively, at least one slide member slidably coupled onto at least one rail.

18. The device of claim 17 further comprising a selectively releasable latch for releasably locking said first slide member relative to said second slide member when said first slide member has been translated relative to said second slide member in said translation direction.
